(19) United States
(12) Patent Application Publication
(10) Pub. No.: US 2010/0162174 A1
(43) Pub. Date: Jun. 24, 2010

(54) Flat Navigation of Information and Content Presented on User Monitor

(76) Inventors: RON KARIDI, Herzeliya (IL); Oded Elyada, Tel Aviv (IL); Liza Fireman, Atlit (IL); Hen Fitoussi, Tel Aviv (IL); Roy Varshavsky, Tel Aviv (IL); Eran Yariv, Zichron (IL)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(21) Appl. No.: 12/344,104

(22) Filed: Dec. 24, 2008

(51) Int. Cl. G06F 3/048

(52) U.S. Cl. 715/854

(57) ABSTRACT

A method of presenting information on a display monitor within a computing environment includes accessing a website containing a related collection of electronic pages, crawling the website to obtain raw image data for at least some of each of the pages, porting the raw image data into a template so that each of the crawled pages is converted into a corresponding information panel containing a mapping of the content of its respective corresponding page, and displaying each of the information panels on a respective display monitor so all of the panels are viewable to a user in a single screen shot. Related methods, apparatus, and systems are further provided.

### TECHNICAL FIELD

This invention relates in general to computing and in particular to the presentation of electronic documentation, images, and other information in a computing environment. More specifically, but without restriction to the particular embodiments hereinafter described in accordance with the best mode of practice, this invention relates to methods, apparatus, and systems for providing flat navigation and exploration of information and content presented on a user video monitor.

### BACKGROUND

Today when a computer user browses a website, typically only one page of the site is present at a single time. This is true even when using multiple tabs or windows. The current user experience lacks the context of other pages in the site while viewing a home page for example, or while on any other particular page in the site. Thus the user of a website being limited to viewing only one page at a time is often not sure which pages are relevant to his or her interest even after spending some considerable time browsing the site.

Navigation within the typical website is usually guided by internal links, in a way that does not allow full exploration of the site or knowledge when all pages have been viewed. As a result, a page typically cannot be accessed unless the user knows its address or has clicked there via a link from other page.

As a partial remedy, many site owners publish a map of the pages included in the site. This is known typically as a sitemap. However, this hierarchical representation is designed by the site owner and usually is static thus requiring maintenance with updates which are not always current. Moreover, this being an unintuitive solution, disconnected from the content, it is therefore rarely used by typical website users. Other solutions such as key word search within a site require an explicit intent and knowledge of the site's terminology and thus cannot be used effectively for exploration.

### SUMMARY

This Summary is provided to introduce select concepts hereof in a simplified form that are further described below in the Detailed Description. This Summary is not intended to identify all key elements, characteristic functionalities, or essential features of the claimed subject matter, nor is it intended in any way to limit the scope of the claimed subject matter.

Thus with the above in mind, one aspect of the present invention is directed to presenting the entire content of a website in a flat manner so that the user is exposed to all pages at once. In order to maintain the context of the pages, this full-content representation may be structured. The various structured layouts of the pages may advantageously preserve their respective relationships such as, for example, similarity, classification, and hierarchy. More specifically, for example, in presenting the full contents of a newspaper according to the teachings hereof, all the front page new stories may be grouped or clustered together, all the business articles also so clustered, then all the sports. articles may be clustered together in relation to one another, similarly all the arts and entertainment contents may be further grouped or clustered, and so forth. In addition, the website user may navigate within the present flat site in either a continuous manner such as by zooming, panning, or scrolling, for example; or in a non-continuous manner such as via links. Thus with these and other features and aspects of the various embodiments of the present invention, the user exploration experience is complete.

To provide both complete site observation and detailed investigation, another aspect of this invention is its zoomable capabilities. One such implementing technology that provides smooth multi-resolution representation with deep zoom functionality is Seadragon another is Sliverlight both from Microsoft of Redmond, Wash. In this manner, a user of a website presented according to the teachings hereof, may employ his or her cursor as a pointing device to seamlessly zoom into any presented content so that the pointed to content fills the full screen area of the viewing monitor.

Another aspect of certain and various embodiments of the present invention is directed to providing templates for creating flat websites according to the teachings hereof. Several examples of template formats are discussed in further detail herein below. Thus when designing or exploring a website, a supersite, or a subsite, any one or more of the discussed template formats may be employed to present the information content in the flat manner according to the teachings hereof. And as would be readily apparent to those of skill in the art given this disclosure, a wide variety of different template formats may be devised, adopted, or otherwise designed that while not expressly illustrated herein would nonetheless still be within the scope and spirit of this disclosure and the claims issuing hereon.

Still a further aspect of this invention is to provide a tool that automatically generates zoomable advertisements, as well as zoomable websites, supersites, or subsites, as presented within any one or more of the various templates hereof. The tool receives the raw image and text information and generates the zoomable advertisement or site. The tool includes an option to generate a direct access links menu. The advertisements or sites can be generated in several manners including from a web site containing the relevant information; from a web site section containing the relevant information; and from a set of content items (web pages, documents, and images) together with meta data providing the relative layout within the advertisement. In one particular embodiment, this tool may create several different templatized versions of the site such that the user may toggle between different views, or an original traditional view and a templatized flat-site version thereof.

As used herein the term “site” or “website” is intended to include all of the pages contained within a traditional website such as, for example, a typical university website such as the one that may be found, for example, at www.mit.edu. In addition, as used herein the term “site” or “website” is also intended to include some of the pages from a traditional website forming a related subset of pages such as the pages relevant to the physics department within a particular university website. In this case, the term “subsite” may be employed expressly herein to denote this case of a subset of collected pages as an alternative for the general “site” or “website” usage. Furthermore, as used herein the term “site” or “website” is also intended to include at least some of the pages from two or more traditional websites as may be, for example, presented in the templates hereof for comparison purposes. In this case, the term “supersite” may be employed expressly herein to denote this case of collected pages from two or more traditional sites respectively clustered together and presented in a single flat-site, flat-navigation, or flat-exploration manner. Here for example, the subset of pages from the physics departments at three different universities may be assembled, templatized according to the present teachings, and presented in the flat manner hereof on a single canvas that contains all of the subsite pages from the three different source websites.

More specifically now according to certain specific embodiments of the present invention, there is provided a method of presenting information on a display monitor within a computing environment. This method includes the steps of accessing a website containing a related collection of electronic pages; crawling the website to obtain raw image data for at least some of each of the pages; porting the raw image data into a template so that each of the crawled pages is converted into a corresponding information panel containing a mapping of the content of its respective corresponding page; and displaying each of the information panels on a respective display monitor so all of the panels are viewable to a user in a single screen shot. In one embodiment the information panels are advantageously layered on top of each other in a predetermined manner to thereby create levels of information. Here when the user selects a particular level, the information panels on the particular level enlarge to fill the available viewable space on the respective display monitor to thereby create a full screen shot of the selected particular level. Alternatively, when the user selects a particular information panel, that information panel enlarges to fill the available viewable space on the respective display monitor to thereby create a full screen shot of the selected information panel. In a preferred embodiment hereof the information panels in consecutive levels are smaller than the information panels in a next prior level so that at least a portion of all of the information panels on all levels is viewable in a single screen shot. In another embodiment hereof, there is provided the further step of providing a menu containing a listing of at least some of the levels so that a user may employ the menu to jump from level to level whereupon when a particular level is selected from the menu, the panels on the level adjust in size to fill all the viewable space on the display monitor. Alternatively or in combination therewith, the method may include the further step of providing a menu containing a listing of at least some of the information panels so that a user may employ the menu to jump from panel to panel whereupon when a particular panel is selected from the menu, the particular panel adjusts in size to fill all the viewable space on the display monitor.

According to another aspect of this method there may be provided the further step of providing a link on one level so that a user may employ the link to jump to a different level whereupon when the link is employed, the panels on the different level adjust in size to fill all the viewable space on the display monitor. Or alternatively the further step of providing at least one link in one information panel so that a user may employ the link to jump to a different information panel whereupon when the link is employed, the different panel adjusts in size to fill all the viewable space on the display monitor. And in a particular implementation hereof, the above crawling step may advantageously include obtaining raw image data for all of the pages in the website.

In accordance with another principal aspect of this invention, there is provided a networked computer system for use in presenting a related collection of electronic pages in a flat format. This computer system includes at least one server including stored pages capable of being searched and retrieved electronically; memory for storing a search engine including a ranker and executable methods of searching for desired types of the stored pages; an input device for inputting a search query directed to retrieving a respective collection of the desired types of the stored pages; a processor operatively linked to the input device for processing the search query; a browser operatively associated with the processor for cooperatively engaging a front end of the search engine so that when the search engine receives the search query from a user, the search engine retrieves a set of the stored pages relevant to the search query; a template that receives each retrieved page in a predetermined format so that each retrieved page is converted to a corresponding information panel; and a display monitor for displaying each of the information panels so all of the retrieved and converted pages are viewable to a user in a single screen shot. In one particular application hereof, the retrieved pages are obtained from at least two different websites.

According to another aspect of certain embodiments of the present invention there is further provided a specific method of arranging and presenting information on a display monitor within a computing environment. This particular method includes the steps of accessing a website containing a related collection of electronic pages; crawling the website to obtain raw image data for at least some of each of the pages; porting the raw image data for each of the pages into a corresponding information panel containing a mapping of the content of its respective corresponding page; arranging the information panels in a desired format; and displaying each of the information panels on a respective display monitor so all of the panels are viewable to a user in a single screen shot. Here information panels may be layered on top of each other in a predetermined manner to thereby create levels of information. In this case, when the user selects a particular level, the information panels on the particular level enlarge to fill the available viewable space on the respective display monitor to thereby create a full screen shot of the selected particular level. Alternatively, when the user selects a particular information panel, that information panel enlarges to fill the available viewable space on the respective display monitor to thereby create a full screen shot of the selected information panel. In a particular instantiation hereof, the information panels in consecutive levels are smaller than the information panels in a next prior level so that at least a portion of all of the information panels on all levels is viewable in a single screen shot.

In accordance with another aspect of this method, there is provided the further step of providing a menu containing a listing of at least some of the levels so that a user may employ the menu to jump from level to level whereupon when a particular level is selected from the menu, the panels on the level adjust in size to fill all the viewable space on the display monitor. Alternatively, the method may provide the further step of providing a menu containing a listing of at least some of the information panels so that a user may employ the menu to jump from panel to panel whereupon when a particular panel is selected from the menu, the particular panel adjusts in size to fill all the viewable space on the display monitor. And in combination therewith or alternatively, the method may further include the further step of providing a link on one level so that a user may employ the link to jump to a different level whereupon when the link is employed, the panels on the different level adjust in size to fill all the viewable space on the display monitor.

### BRIEF DESCRIPTION OF THE DRAWING FIGURES

Further aspects and characteristics of the embodiments of the present invention together with additional features contributing thereto and advantages accruing therefrom will be apparent from the following description of certain embodiments of the invention which are shown in the accompanying drawing, wherein:

FIG. 1 is a block diagram representing typical elements in a computer operating environment in which embodiments of the present invention may be implemented;

FIG. 2A is a pictorial representation of a computer system network including a search engine and electronically stored and searchable documents;

FIG. 2B is a flow chart showing various steps in using the present development tool to create a flat site according to the teachings hereof;

FIG. 3 is a graphical representation of one embodiment of presenting image and textual information in a flat site manner according to the present invention;

FIG. 4 is a graphical representation of another embodiment of presenting website information on a video monitor according to this invention;

FIGS. 5A-5E are graphical representations of yet another particular embodiment of presenting information in accordance with this invention;

FIGS. 6A-6D illustrate an example of presenting advertisement information according to the flat-site aspects of this invention;

FIGS. 7A-7D show an example of presenting a subsite of an auto manufacture's dealership network with links to individual dealership sites wherein all the site material is present in the flat-navigation format hereof; and

FIG. 8 illustrates an example of a supersite assembled, templatized, and presented in the flat manner hereof.

### DETAILED DESCRIPTION

The subject matter of the embodiments of the present invention is described with specificity herein to meet statutory requirements. However, the description itself is not intended to limit the scope of the claims of any patents issuing hereon. Rather, the inventors have contemplated that the claimed subject matter might also be embodied in other ways, include different steps or combinations of steps similar to the ones described herein, or used in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

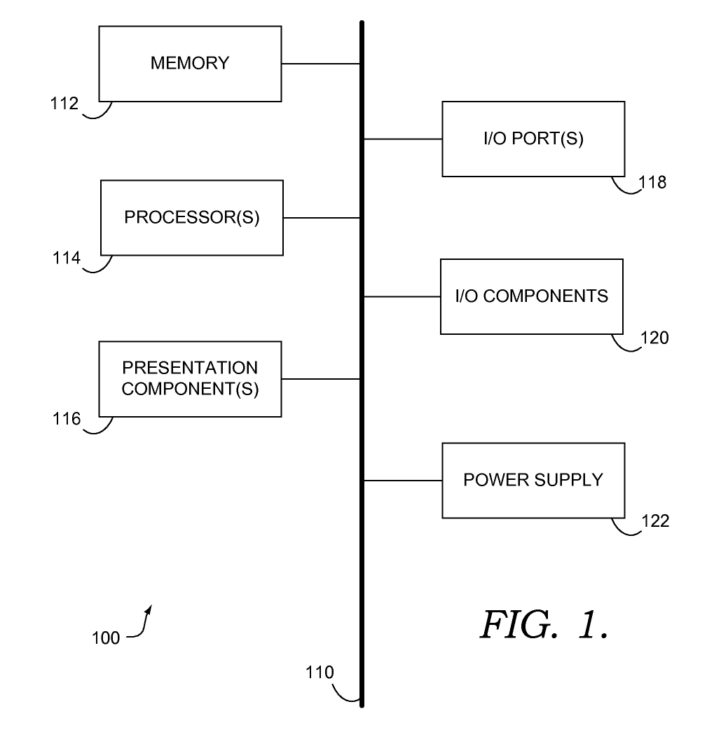

Having briefly described above an overview of certain embodiments of the present invention, an exemplary operating environment for the various embodiments of this invention is next described. Referring now to FIG. 1, an exemplary operating environment for implementing embodiments of the present invention is shown and designated generally as computing system or device 100. Computing device 100 is just one example of a suitable computing environment and is not intended to suggest any limitation as to the scope of use or functionality of the invention. The inventors hereof envision that the inventions disclosed herein may be readily applied in a wide range of computing devices, systems, or environments whether networked or stand alone including for example, desktop PCs, hand-held computing devices, navigation systems, digital radios, home entertainment systems, and any other known or future computing environment where the display of pages from a website is desired. Thus the computing environment 100 should not be construed as having any particular dependency or requirement relating to any one or combination of the components or modules illustrated. Certain aspects and embodiments of the present inventions may be described in the general context of computer code or machine-useable instructions, including computer-executable instructions such as program components, being executed by a computer or other machine, such as a personal data assistant or other handheld device as discussed above. Generally, program components including routines, programs, objects, components, data structures, and the like, refer to code that performs particular tasks, or implement particular abstract data types. Embodiments of the present invention may be practiced in a variety of system configurations, including hand-held devices, consumer electronics, general-purpose computers, specialty computing devices, and so forth, whether known today or developed subsequently hereto. Embodiments of the invention may also be practiced in distributed computing environments where tasks are performed by remote-processing devices that are linked through a communications network.

With continued reference to FIG. 1, computing system 100 includes a bus 110 that directly or indirectly couples a memory 112, one or more processors 114, one or more presentation components 116, input/output (I/O) ports 118, 1/0 components 120, and an illustrative power supply 122. Bus 110 represents what may be one or more buses such as those that may include an address bus, a data bus, or a combination thereof. Although the various blocks of FIG. 1 are shown with solid line connections which may represent a hard wire connection, any one or more of the elements may be wirelessly connected where desired, appropriate, or technically feasible. In addition thereto, certain hardware/software implementations hereof may include a wide variety of various components and functionalities so the elements illustrated in FIG. 1 are to be taken only as exemplary and not limiting in any intended or particular manner. For example, one may consider a presentation component such as a display to be both an input and output component since some current displays with touch features allow a user to manipulate on screen displayed items. Also, processors have memory as those skilled in the art would readily appreciate. The inventors hereof recognize that such is the nature of the art, and reiterate that the diagram of FIG. 1 is merely illustrative of an exemplary computing device or system that can be used in connection with one or more embodiments of the present invention. Distinction is not made between such categories as “workstation,” “server,” “laptop,” “hand-held device,” or the like, as all are contemplated within the scope of FIG. 1 and reference to as “computer”, “computing device”, or “computing system.”

Now more specifically, the computer 100 typically includes a variety of computer-readable media. Computer-readable media includes any available media that can be accessed by computer 100 and encompasses both volatile and nonvolatile media, as well as removable and non-removable media. By way of example, and not limitation, computer-readable media may include computer storage media and communication media. Computer storage media includes such volatile and nonvolatile, removable and non-removable media implemented in any method or technology for storage of information such as computer-readable instructions, data structures, program modules or other data. More specifically, computer storage media includes, but is not limited to, RAM, ROM, EEPROM, flash memory or other memory technology, CD-ROM, digital versatile discs (DVD) or other optical disc storage such as Blu-ray or HD-DVD, magnetic cassettes, magnetic tape, magnetic disk storage or other magnetic storage devices, or any other medium which may be used to store the desired information and which can be accessed by computer 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope and meaning of computer-readable media.

Memory 112 includes computer-storage media in the form of volatile and/or nonvolatile memory. The memory 112 may be removable, non-removable, or a combination thereof. Exemplary hardware devices include solid-state memory, hard drives, optical-disc drives, and other such current or future devices that would provide the desired functionality. Computing device 100 includes one or more processors 114 that read data from various entities such as memory 112 or I/O components 120. Presentation component(s) 116 present data and/or sensory indications to a user or other device. Exemplary presentation components include a video display, speaker, printing component, vibrating component, and any such current or future presentation components. I/O ports 118 allow computing device 100 to be logically coupled to other devices, including I/O components 120, some of which may be built in. Illustrative components include a microphone, joystick, game pad, satellite dish, scanner, printer, wireless device, and others as desired, appropriate, or technically feasible.

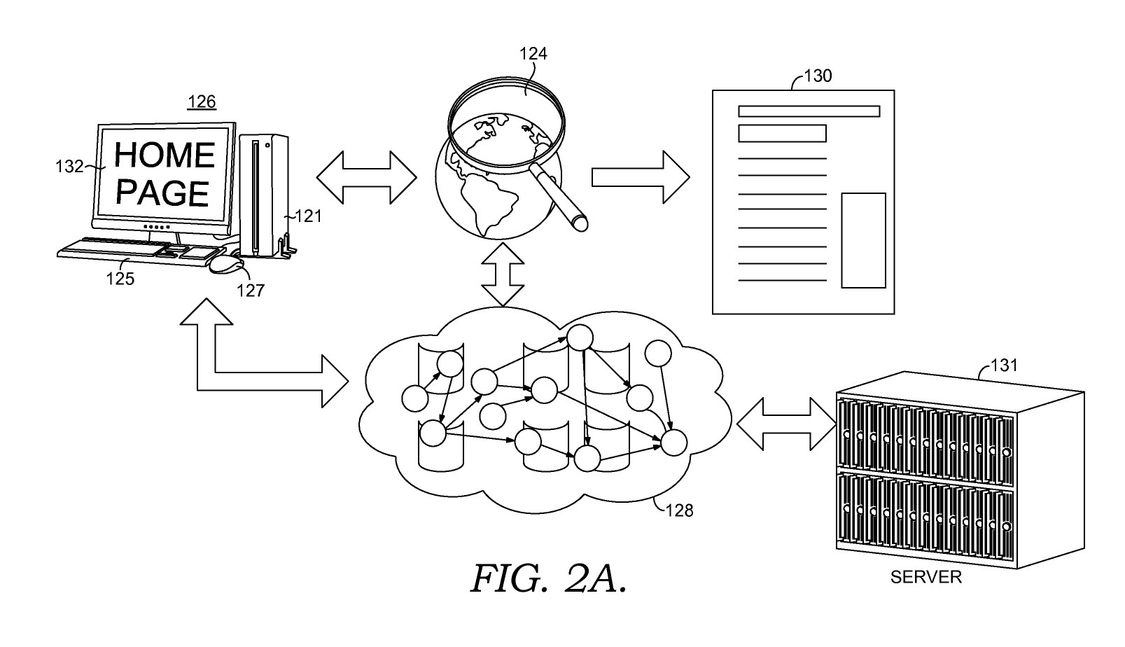

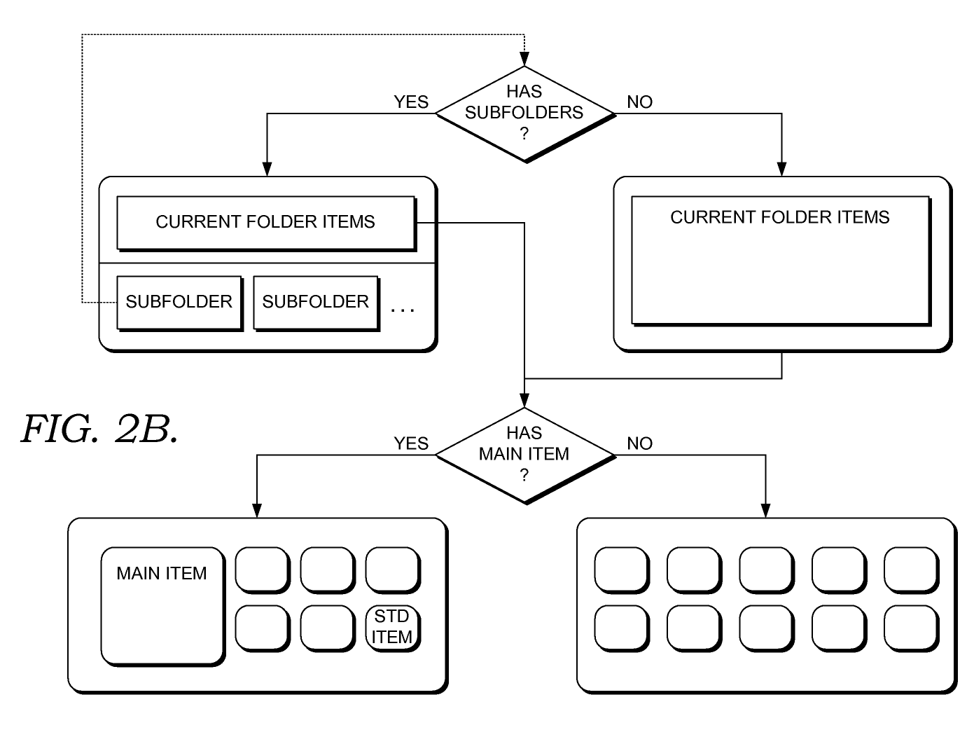

With reference next to FIG. 2A, there is shown a pictorial representation of a computer system network including a search engine and electronically stored and searchable documents contained in their respective websites. FIG. 2A shows a graphical representation of a search engine 124, a desktop personal computer system 126, a representation of the Internet 128, a graphical representation of search results 130, and a server 131 which may host a particular website having dozens or even hundreds of individual pages. The desktop PC includes a typical computer tower 121, keyboard 125, mouse 127, and video monitor or viewing screen 132.

As would be apparent to those of skill in the art, there are various search engines available and such search engines are readily accessed via a computer device as enabled with Internet access. The typical search engine is a bundle of software components residing typically in a distributive computing system including a number of linked servers. The search engine may include a ranker or dynamic ranker component or module which is employed to rank the results according to categories within a taxonomy and priority score as those of skill in the art would appreciate.

The server 131 is similarly a cluster of hard drives here illustrated as blade-type drives mounted in a server rack. As would be appreciated by those of skill in the art given the present disclosure, some of the methods hereof when embodied in software as executable code would reside on and interact with the hard drives of the server 131 while others hereof would reside on the hard drive maintained in the computer tower 121 of the PC 126. Further, the typical search engine has a front end which interacts with an Internet browser, for example, which browser would typically reside on the hard drive of the personal computer 126 or any other personal computer such as a hand-held computing device. Thus when a user of a personal computer types a search query, the processor of his personal computing device interacts with the local browser, which in turn interacts with the front end of the search engine, which then executes the required search over the various documents and websites stored and available generally from the Internet and next in conjunction with various protocols and implementing software engages the ranker to created a sorted or prioritized listing of documents and websites as the output or search results 130. Search results 130 based on a search query are typically tabulated, listed, or otherwise presented in some fashion by search engines and their associated hardware and software including the dynamic ranker, on the video display monitor 132 accessible by the user and part of the users personal computing device. One application of the present invention is to present these search results in the flat manner herein described. Thus rather than having several pages of possible responses to the search query listed in laundry list fashion, the search results are presented in the flat manner with the listed items having the higher probability of being responsive to the search query presented in larger image panels and those “hits” which would otherwise be listed at the end of the pages of listed search results, presented on the same page in one master canvas but in relatively smaller panel sizes. Thus herein according to this aspect of the present invention, the user's browser interfaces with the front end of the search engine which performs a search based on a particular query. The ranker then in combination with the search engine will retrieve from the Internet the various documents and websites which are responsive to the query. The tools and templates provided herein next interact either with the search engine server or when resident locally, with the hard drive of the PC of the user to crawl the various retrieved pages, process them accordingly, templatize them in any desired flat presentation manner, and display them accordingly on the users monitor 132. Example 3 below presents an illustrative embodiment of the present invention which is directed to utilization of a search engine for retrieving search results in response to an query and presenting the search results in the flat site manner of the present invention. In one particular embodiment, the processing tools hereof may create several different templatized versions of the site such that the user may toggle between different flat-site views, select a preferred flat canvas view, or toggle between an original traditional view and a templatized flat-site version thereof.

The in-context linked flat site of the present invention is an alternative display of websites. According to the teachings hereof, websites are organized, in a manner such that all their pages are presented together in one exposure on one canvas. The user can zoom out and see the entire site at once. This fully zoomed out state allows for overall impression of the site organization, content, layout, and richness. The user can also zoom in to read a single page, or even further, a single paragraph or view one detailed image. A user reaches a fully zoomed in state or condition when the textual or image information presented in a particular site is at its highest or deepest level of detail as designed to be so presented. For example in the case of a newspaper presented in this manner when all the sports articles may be clustered together in relation to one another, the user may find an article about the prior night's baseball game and learn that his favorite player had 4 hits over 4 at bats, thus going 4 for 4 that game. The user may then zoom further into the context present to a listing of all the players current batting scores, then zoom to the deepest level to find the batting score of his favorite player. In an “in between” state or condition the user is capable of exploring subsections or subsites of the site such as, for example, the individual pages of a particular section of a newspaper which sections may include the front page, nation & world, region & state, marketplace, local, sports, life & food, and the classifieds. This multi-resolution exploration allows for rich visual representation of the site. The zoom out, lower resolution state facilitates exploration-like browsing as it allows for exceptional visual objects to ‘pop up’ and catch the eyes. The inventors hereof believe that by providing smooth, infinite resolution level, Seadragon is a preferred technology to implement flat site. It should, however, be understood by those of skill in the art that other implementing technologies may be employed to deliver the zoomable aspects of this invention to a user of a computer system as described above.

Navigation within the flat site may be achieved in many ways. One embodiment thereof includes zooming in, zooming out, or moving to an in-between state as described above. The inventors hereof believe that smooth zooming (as in Seadragon of Silverlight) allows for an improved exploration experience. A second embodiment of navigation in the present flat site invention is by use of panning and scrolling. This 360 degree, continuous movement along or around the site, allows for easy, smooth browsing. This is beneficial for continuous operations, such as reading, leafing through pages, and image observing. A third embodiment of navigation in the present flat site invention is by a hyperlink experience. This allows for jumping from one place in a site to another, distant or remote location in the site. This use of hyperlinks in the present flat site configuration also allows for switching between contexts while staying in the site. The links that allow these leaps may be created by the site author (as with standard hyperlinks), created by the user (as dynamically marking two locations as connected), or auto-generated by a server/client/3rd party service by analyzing the content of the pages. Jumps between locations may be achieved either by preserving the zoom level or by changing it.

The navigation alternatives significantly improve the exploration experience, as they present improved functionalities (for example, leafing through), reduce the constraints of the current methods (for example, as links are not restricted to the links that the site author designed), and in general, allow more diverse options. Moreover, as the user is the one that controls the zoom level, position, and the way to move between positions, the browsing context is controlled.

Another aspect of the present invention is directed to creating flat sites. A flat site may be either automatically generated from a standard site by crawling it and transforming it to a flat site format, or manually by providing a flat site editing tool. The two alternatives allow for easy, seamless, and more importantly, dynamic maintenance, and porting of any “static” site to the new format.

As stated above, the site display may be either unstructured as for example presented in a matrix layout, or structured wherein similarity, classification, and hierarchy are employed. A structured organization may be either predefined, typically by code or by the site author, or interactive such as by time, content, tags, authors, or as otherwise desired. In particular, tagging according to aspects hereof is desired to enhance the enrichment of the flat site concept, because it allows for interactive, dynamic, pivoting and organization.

Hierarchy levels may be determined in multiple ways. For example, hierarchy levels may be determined by 1) explicit links to pages in the site, 2) a file system or web path structure, or 3) adding implicit links.

The inventors hereof distinguish between two high-level approaches for organizing the site content. Thus a first embodiment of organizing website content according to these aspects of the present invention is a template based methodology, and the second is a full manual approach.

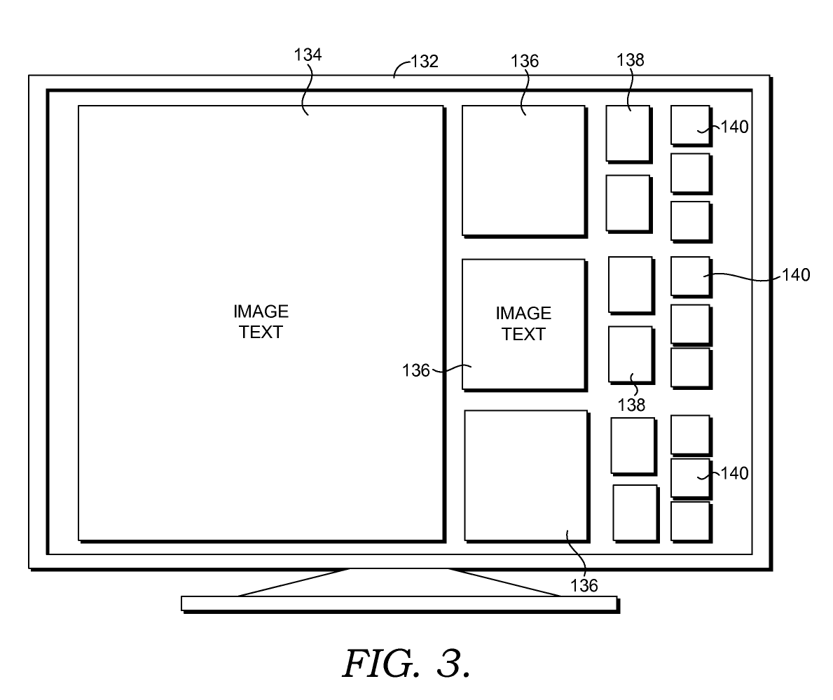

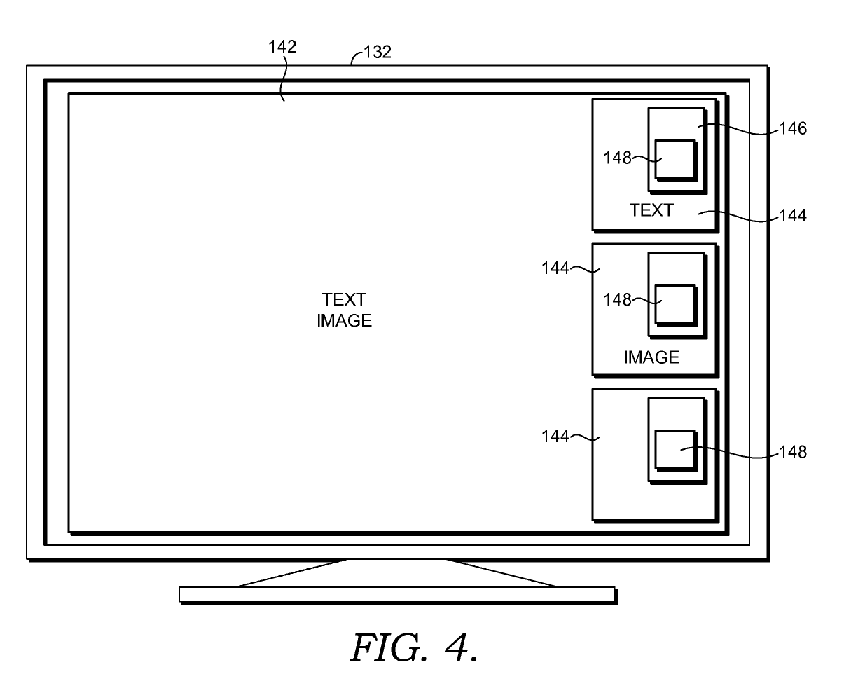

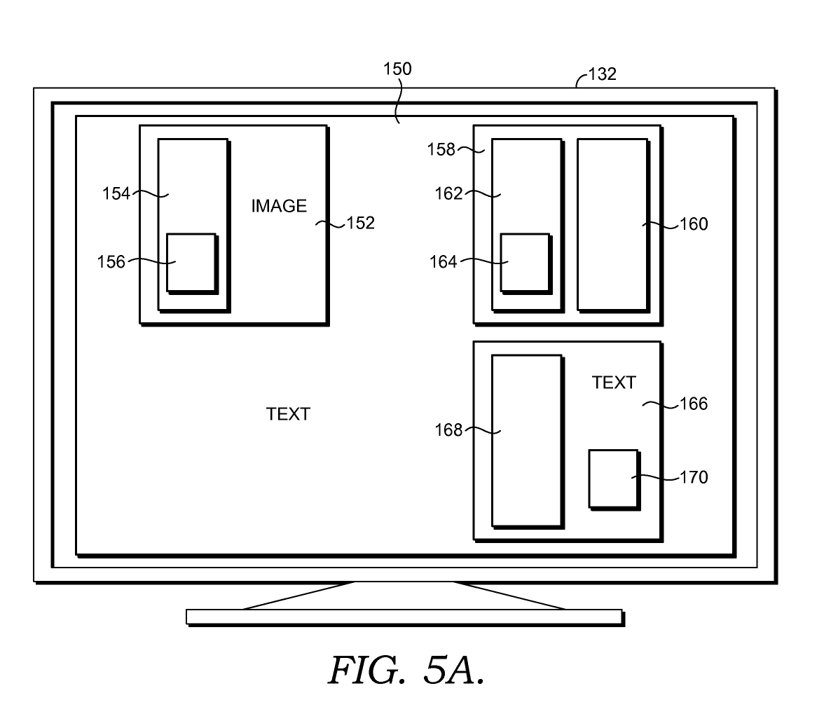

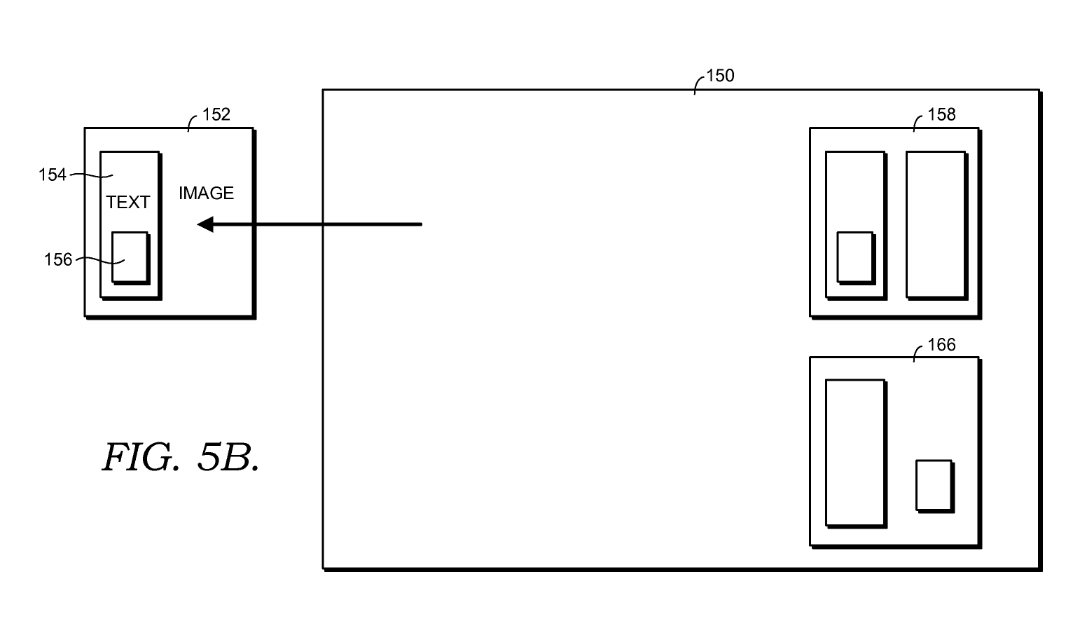

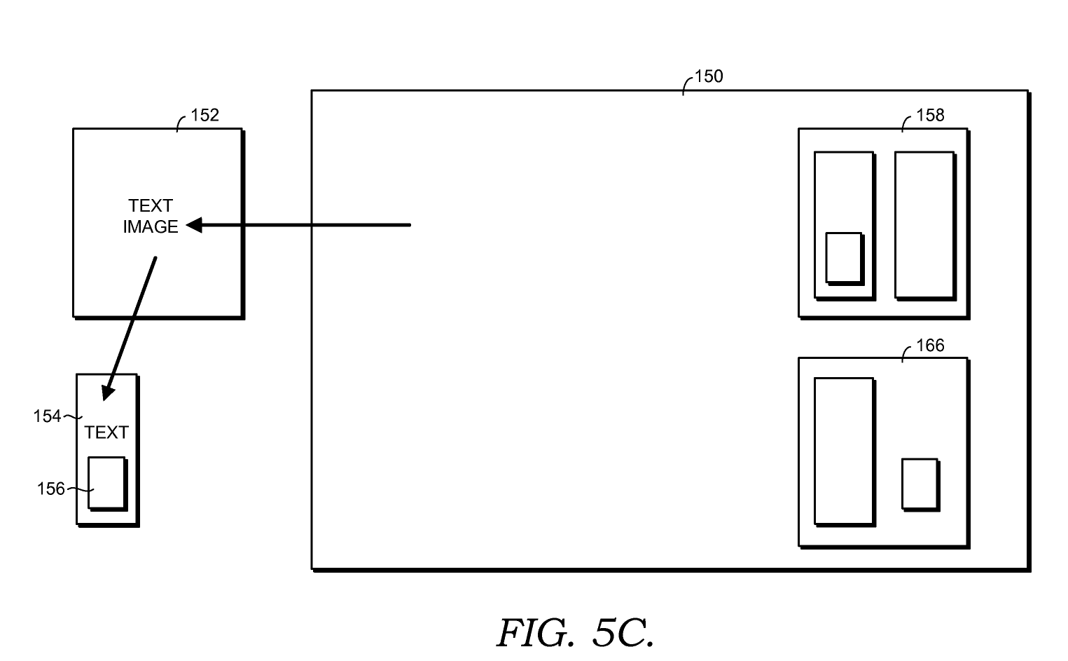

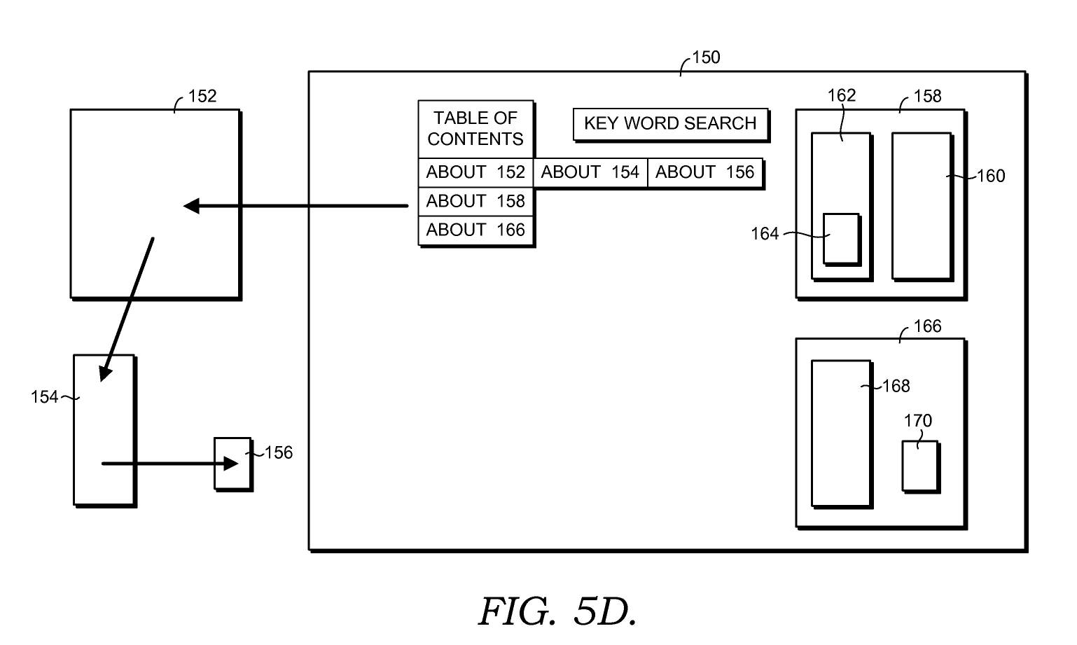

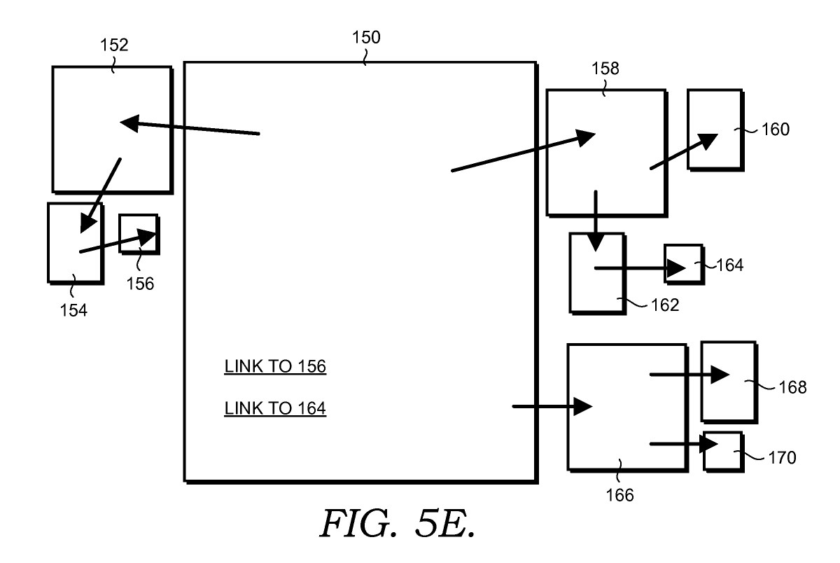

In the template based approach according to the teachings hereof, the user selects between several layout templates such as, for example, those discussed below in conjunction with FIGS. 3, 4, 5A, and 6A. Here according to the template based methodology, the user may set any number of different layout parameters such as, for example, size ratio for drill down. Drilling down one level translates to laying out the elements of the next level beside, on top, or at the bottom of the current item. The final result may have several layers or levels fully expanded as will be discussed in further detail herein below. Drilling down translates to embedding smaller instances of the next level elements within the parent elements of the current level as shown, for example, in FIGS. 4 and 5A.

According to the fully manual methodology, the authoring tool extracts the web pages automatically from the site, and the user may then manually organize them on the canvas, with control for size and location of each element as represented, for example, in FIG. 5E. This may be performed by an end user who has accessed the site over the Internet or by a web designer either converting an existing site in the traditional format or creating a new site in this flat canvas manner. Thus in this manner, the user or designer may apply this tool to create a single screen canvas wherein all the pages of the site are presented in the present flat-format in one of many possible different self-designed configurations.

With reference now to FIG. 2B, there shown is a flow chart illustrating various steps in using one particular embodiment of the present development tool to create a flat site according to the teachings hereof. Here first is discussed the use of this tool by a website publisher or developer. Typically the web publisher has their site content (HTML, figures, and any other desired content) saved or stored in their servers' disks. That content is stored in folders in a hierarchical manner. Here then the inventors provide this tool for the publisher to create a flat navigation site for that content. One particular embodiment of this tool is next described in conjunction with FIG. 2B.

Initialization: Start with giving an input which is the root location (folder) on the disk. Then select one of the possible templates as, for example, any of those discussed below in connection with FIGS. 3, 4, 5A, or 6A.

Data Structure Creation: Then an algorithm that maps the hierarchical structure of the disk is run. When the algorithm is done a hierarchical representation is ready.

Template Preparation: According to the template formats a different preparation algorithm is called. The algorithms differ in the way they layout the content in the virtual canvas.

Next is describe an example for such an algorithm. Due to the hierarchical nature of the data structure, the algorithm is recursive. The algorithm runs on folders. Possible content types in each folder:
Main item (the representative item of every folder).
Standard item such as image, html. and more.
A folder (that may include main items, standard items, or subfolders).
   For every folder check its content:

The standard items arrangement is done by maximizing the size of each item according to the space constraints.
Approval and Editing: After the template is ready, the publisher is allowed to edit/modify the overall layout according his or her needs. Links are added either in an automatic way or manually by the publisher.

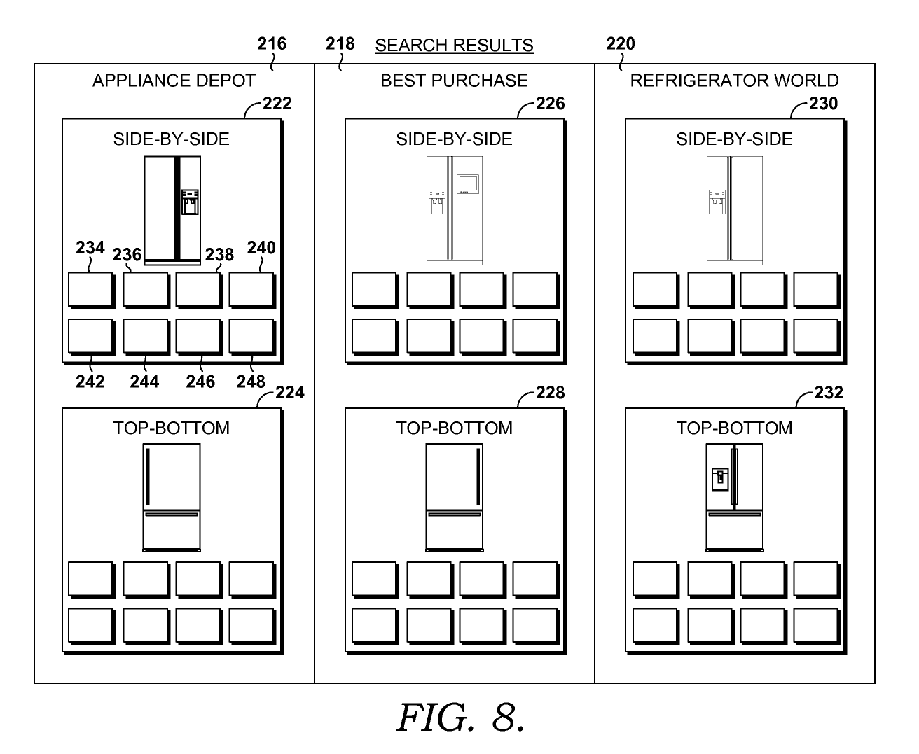

Another aspect of this invention is directed to providing a tool that a computer user may install on the hard drive of this personal computing device and employ when visiting a traditionally organized website. This tool is directed to converting such a traditionally organized website to a flat site according to the teachings hereof. Various embodiments of this tool have the further capability of presenting the flat site material in any of the flat site configurations discussed above in connection with FIGS. 3,4, 5A, and 6A which may be templatized for example, or any other flat site presentation formats that may be desired and self-designed by the user. For a client tool the above publisher tool may be employed, with the change that the data structure creating is not done by mapping the hierarchical disk structure but rather by crawling the site from the homepage onward. A similar procedure is applied in the case for presenting search results in the present flat manner as discussed above and again in further detail below in Example 3 in conjunction with FIG. 8.

Referring next to FIG. 3, there is shown a graphical representation of one embodiment of presenting image and textual information in a flat site manner according to the present invention. FIG. 3 includes the computer monitor 132 on which each and every page of a particular website is displayed in accordance with the teachings of the present invention. In the embodiment illustrated in FIG. 3, an image and/or text panel 134 is presented as the largest field including information in either or both image and text form relevant or pertinent to the site. Next illustrated are panels 136, which are smaller than the image and text panel 134. Here in this embodiment, three such image and text panels 136 are shown and are juxtaposed or positioned next to the image/text block 134 as illustrated. FIG. 3 also shows a series of text and/or image blocks 138 which are smaller than the information blocks 136 and therein include six such image and text blocks. And lastly illustrated in this embodiment of the present flat site invention here in FIG. 3 are text blocks 140, as illustrated these nine such text blocks are the smallest size. It being understood in view of the present disclosure that each and every of the text and image blocks 134, 136, 138, and 140 would contain viewable information in the form of images and/or text of relevance to the website so presented to the user. Thus when a user first accesses this particular website from his browser, all 19 pages are fully viewable. It should be further understood that the image and textual information presented in the panels or blocks is not necessarily limited to still information but may includes moving information such as banners, simulated vibration, or pulsing text, or otherwise include moving images in the form of video clips or movie segments, or in certain embodiments even full length feature films.

Referring next to FIG. 4, there is shown a graphical representation of another embodiment of presenting website information on a video monitor according to this invention. Here in FIG. 4, the alternate embodiment of the flat site illustrated on the monitor 132 includes a full-sized text and image parent block 142. Image and text block or panel 142 is full-sized in that it covers the entire viewable area physically available on the monitor 132. As illustrated in this embodiment image and text blocks 144 are overlaid on top of or embedded into image block 142 and contain viewable text and images as illustrated except in the areas where the subsequent blocks are overlaid or embedded therein. And here image blocks 144, to the extent that they overlay on top of the large image block 142, obscure any information presented in registration thereunder. Further illustrated in FIG. 4 are image and text blocks 146 which to the full extent of their respective areas overlay on top of each corresponding image block 144 in a similar manner as image blocks 144 overlay atop the image and text block 142. Lastly as illustrated in FIG. 4, the smallest image blocks 148 are shown overlaid on their respective image blocks 146, which in turn overlay atop their corresponding image blocks 144. Thus according to the present invention in this embodiment, all of the text and image information is presented in one view as distributed among the various image blocks 142, 144,146, and 148 except for a small percentage thereof where the concentric blocks overlay one another as discussed above. Here as with the embodiment of FIG. 3, the viewer of the website in this flat-site format has ready access to each and every page of text and image in this 10 page website illustration.

Here it should be understood by one of skill in the art given the present disclosure that the embodiments of FIGS. 3 and 4 are not necessarily limited to 19 and 10 pages respectively. Given the present teachings hereon, either of these two formats or any others as would be readily apparent to those of skill in this art, may include any desired number of pages from dozens to hundreds.

FIGS. 5A-5E are graphical representations of yet another particular embodiment of presenting information in accordance with this invention. With reference now first to FIG. 5A, similarly shown is the computer or video monitor 132 which includes a full field first level parent image and text block 150. As illustrated, the image block 150 has superimposed thereover three image blocks of equal size 152,158, and 166. As further illustrated, the next level parent image and text block 152 has overlaid or embedded therein information block 154 which in turn has a superimposed, embedded, or overlaid a fourth level image and text block 156. In a similar manner, the correspondingly sized second level image block 158 has third level image blocks 160 and 162 overlaid on the panel 158 while information panel 162 has overlaid thereon a fourth level image block 164. Similarly, image and text panel or block 166 has overlaid thereon two individual third level image blocks 168 and 170 of different initial sizing. Here in this embodiment, information panels 156 and 164 being the deepest embedded at a fourth level contain and present the final detailed information accessible by the navigation and zoomable aspects according to the present invention.

With reference next to FIG. 5B, the zoomable aspects of the present invention will now be illustrated. When a viewer has finished viewing all of the text and image information illustrated in FIG. 5A, presented for example on a website home page, the user may be interested for example in zooming into image 152. As illustrated the user would point and click with his mouse or other input device such as a stylus to any location on image panel 152, that is otherwise not covered by image 154 or 156, and according to the present invention the image block 152 may preferably zoom in and become as large as the full monitor area. Thus, image 152 when selected may increase in size to become as large as needed to fill the entire available viewing area on the image monitor, thus becoming as large as the previous image block 150.

With reference next to FIG. 5C, in the event the user as illustrated here is interested in next looking one level deeper at image block 154 the cursor is moved to any open space on image block 154 and the present system then expands the image in block 154 to preferably fill the entire screen of the monitor. In alternate embodiments, the image block 154 also containing image block 156 may take a smaller portion of the available monitor area which may be three-quarters thereof, or half, or any other preferred ratio which is either set by the designer of the website or made adjustable by the use such as by using the scroll wheel on his mouse.

Lastly in FIG. 5D, the viewer now selects the last image block 156 and according to the teachings hereof when the cursor of the computer system is placed over any area within 156 that block then being selected in one preferred embodiment fills the entire available viewing area of the monitor. In alternate embodiments hereof, image and text block 156 may expand upon selection to fill three-quarters of the available viewing area of the monitor, or half thereof, or any other preferred ratio or portion which is either set by the designer of the website or made readily available and adjustable by the user such as by using the scroll wheel on his mouse for zoom in and zoom out functions.

FIG. 5D also illustrates a further aspect of the present invention relating to providing an alternation navigation tool in the form of a Table of Contents or menu. Thus as further illustrated in FIG. 5D a Table of Contents menu is provided. The Table of Contents menu includes a typical pull-down table wherein the listings or selections therein indicate in brief more about panel 152, or more about panel 158, and more about panel 156. Thus when the user employs the table of contents and clicks on, for example, About 152, the user screen may zoom to fill the full size with panel 152. Alternatively, the user when selecting About 152 from the menu, may select the additional pop-out menu About 154. Here as above, if the user clicks on About 154, the user screen may zoom to include image item or panel 154 in full size with panel 156 embedded therein. Again alternatively, the user may continue with the menu option to select About 156, whereupon clicking thereon the screen will zoom to full size to present only the textural and image information in panel 156.

Another aspect of the present invention is to dynamically generate sub-sites. Here, for example, as illustrated in FIG. 5D key word search functionality is provided. Thus according to this aspect of the present invention, when the user first arrives at the website and is viewing all of the information contained on the main panel or mother panel 150, the user may immediately create a key word search. Upon executing the key word search the pages in panel 150 will automatically reconfigure themselves such that only pages containing material responsive to the key word search are presented in a new full screen panel presented in place of the original 150 panel. Thus in this manner, the traditional key word searching is rendered operative in conjunction with the flat site tools and templates hereof to produce dynamically generated sub-sites in the flat manner where all pages retrieved from the query within the original website are reconfigured, templatized, and then presented on one canvas to replace the original canvas existing prior to execution of the key word search. Here then, a dynamically-generated subsite based on key word search where the results are presented in this flat format, gives the user the added advantage of instantaneously viewing all retrieved pages in a visual manner so that the one or two pages of most interest to the user are more readily located. This provides a great advantage over the traditional method where a user must read down perhaps several pages of listed “hits”, click on links, read further, go back to the list, click on the next possible hit, and so forth.

Reference now to FIG. 5E is had to illustrate that a user through various steps and zooming has selected, explored, and navigated through each and every available webpage as illustrated. Thus according to this aspect of the invention, a user of the website is assured that each and every page from 150, to 152, to 154, and then down to fourth level 156; from 150, to 158, to 160 and 162, and then again from 162 down lastly here to level four panel 164; and then again from 150 to 166, then to 168 and 170 at level three; have all been viewed and there is no uncertainly that any other pages in the website are available but left unexplored. FIG. 5E also illustrates a further aspect of the present invention directed to in-panel links. Here, two such panel links are illustrated. These include a first link designated as “Link to 156” and a second link designated as “Link to 164”. Here the user may simply click the first link, for example, to jump to image panel 156 or alternatively click the second link to jump to image panel 164. The designer can pick and choose whatever mechanism he desires for a link such as an icon, key word, phrase, thumbnail, or the like. These links may take the user around the canvas on a given level or may allow the user to zoom in our out to different levels while skipping some in-between levels.

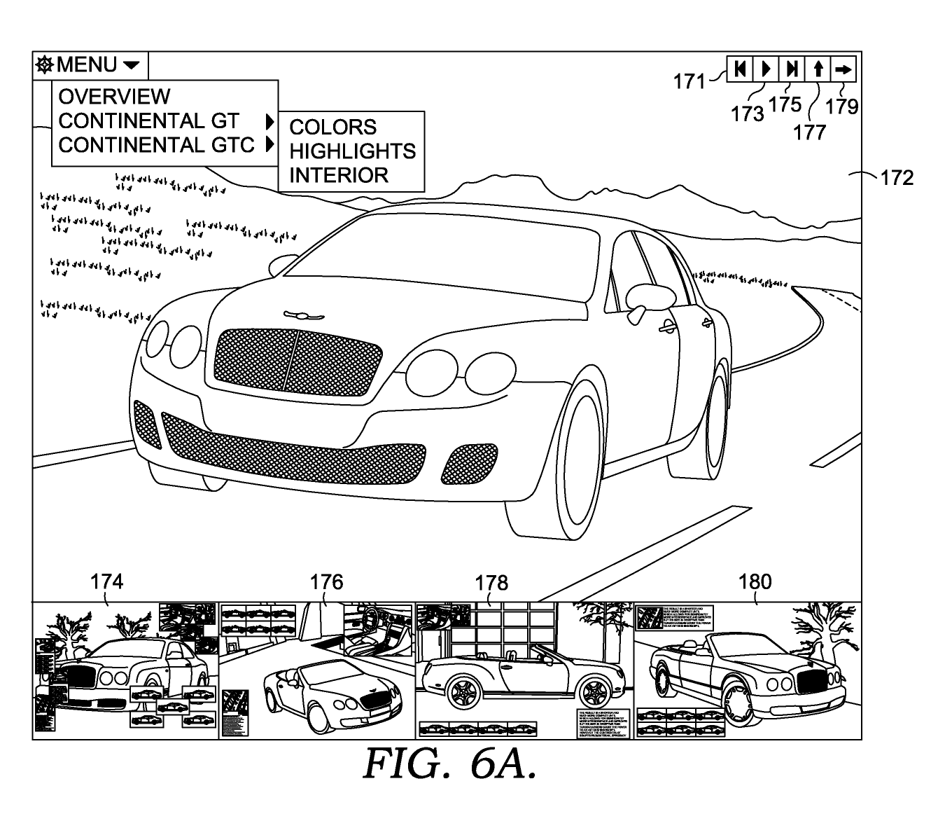

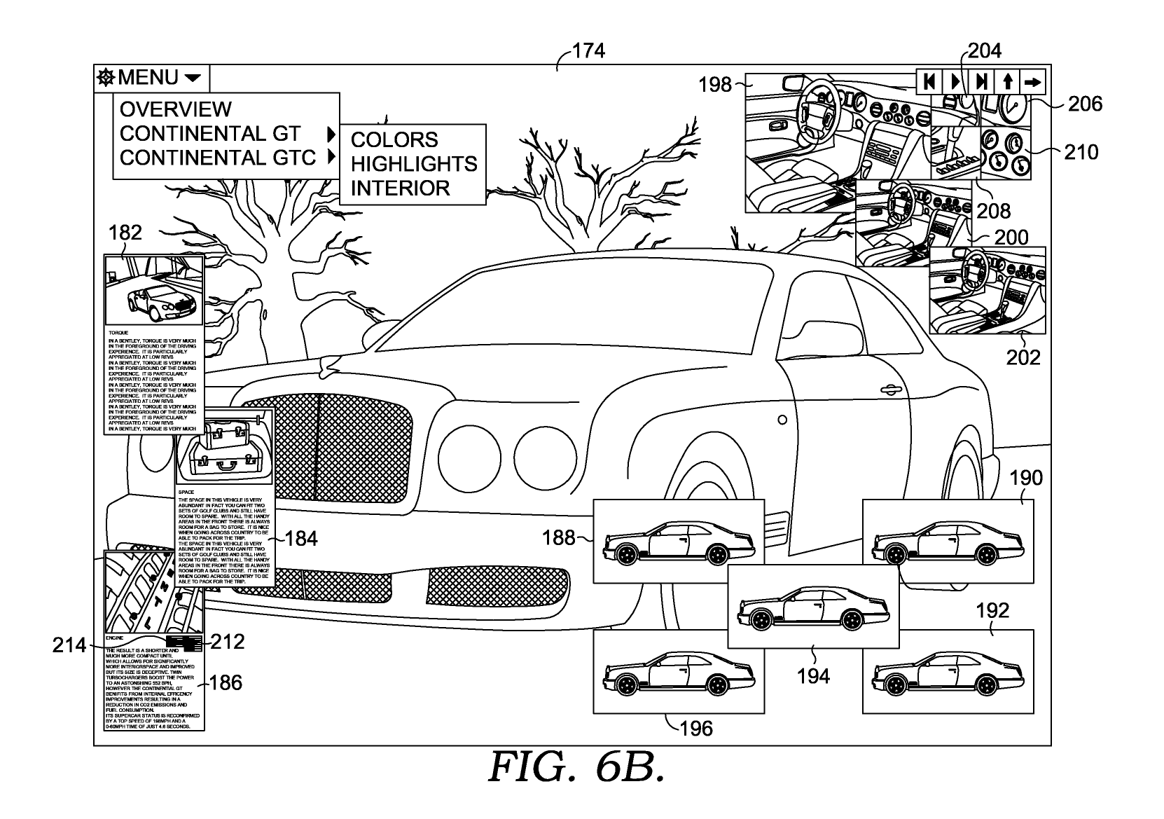

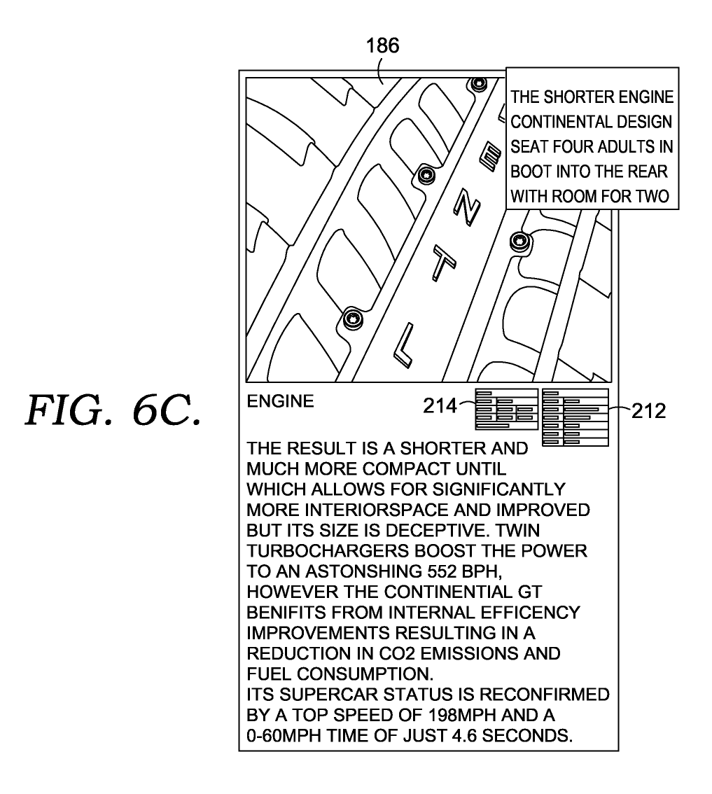

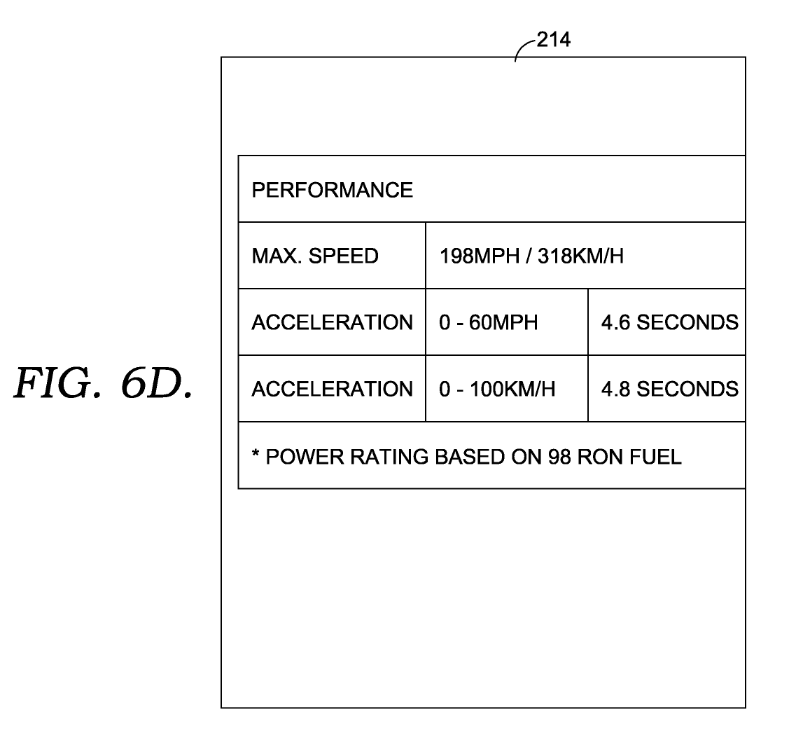

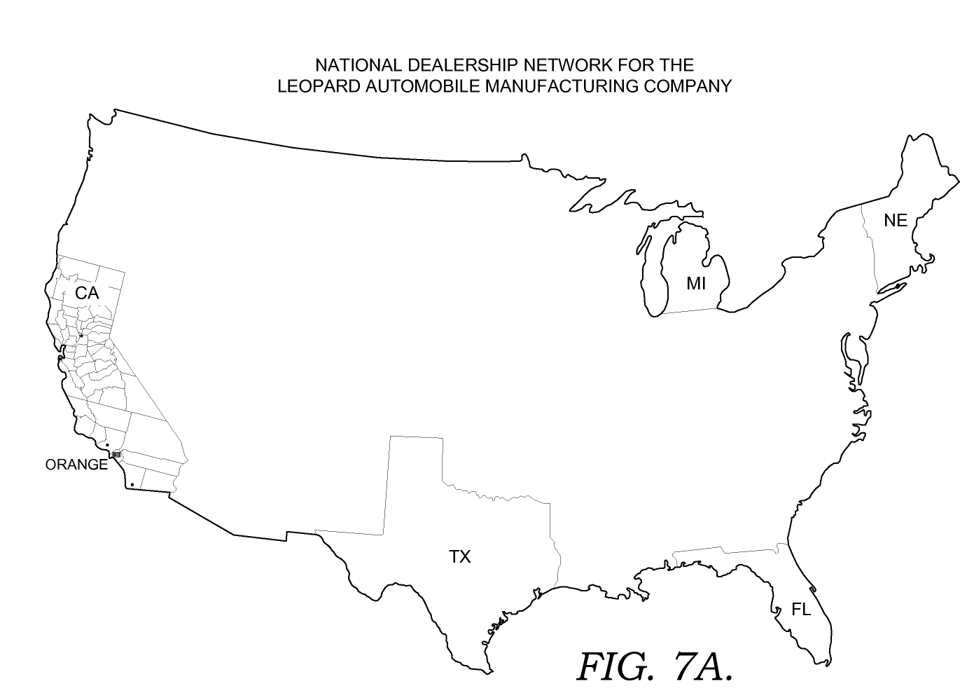

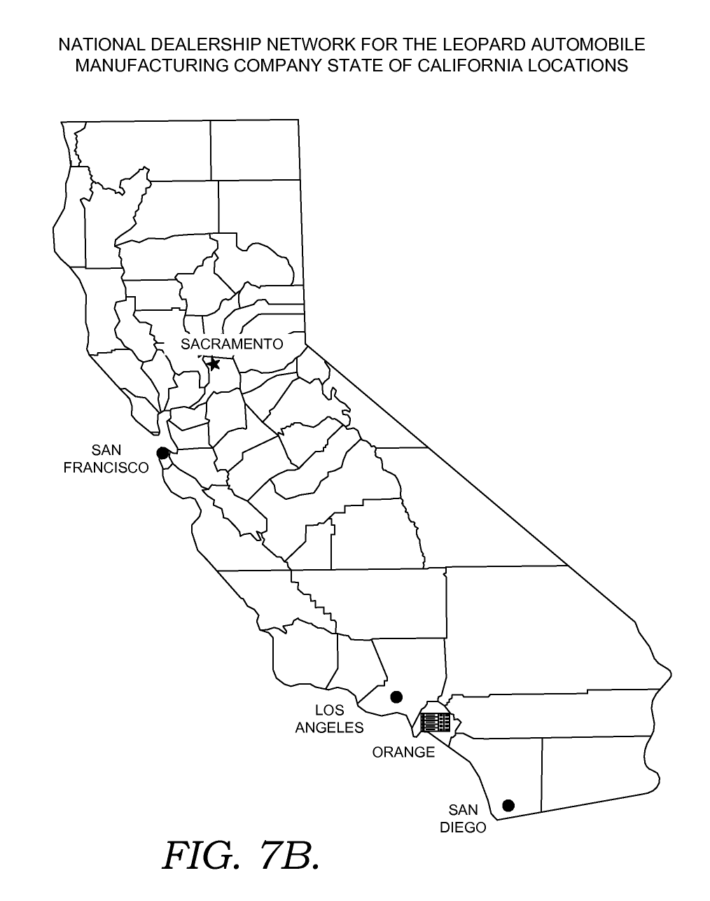

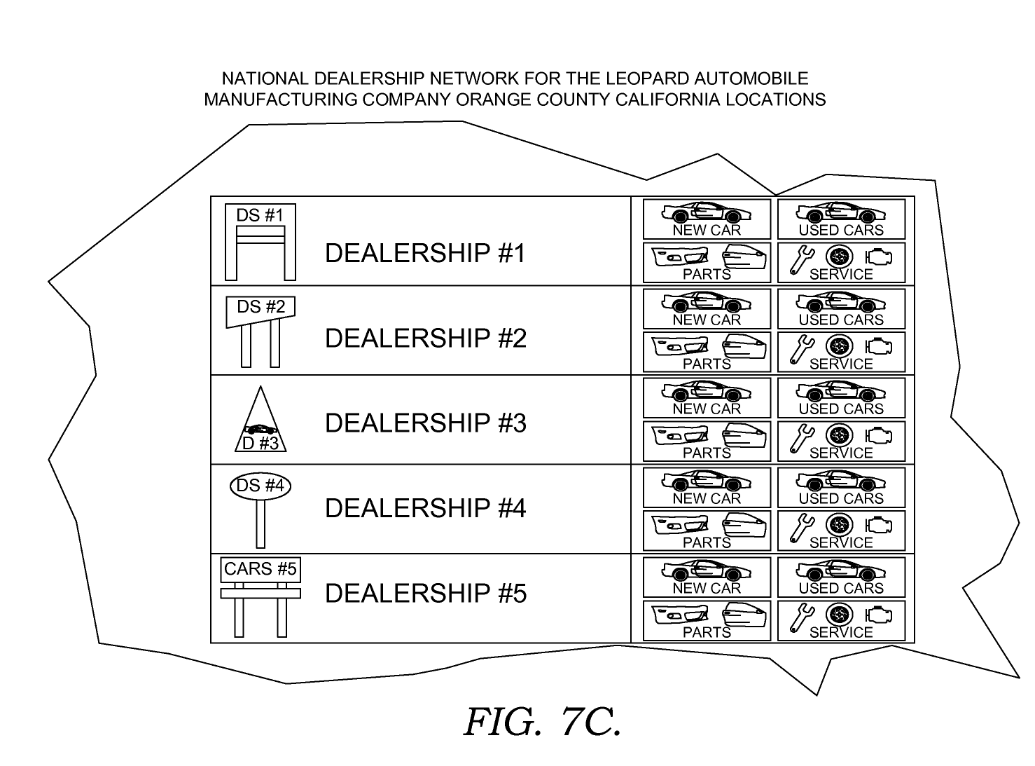

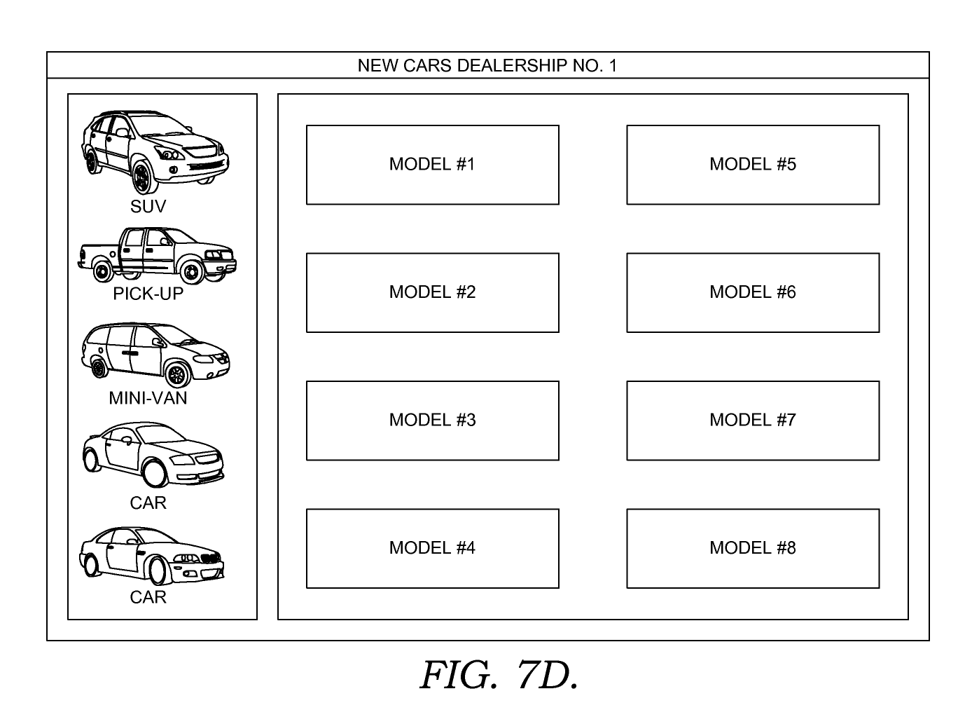

In further view of the detailed description discussed above, next provided are three illustrative examples of some of the described methodologies, aspects, and characteristics of certain selected embodiments hereof as directed to presenting advertizing material in a flat site manner as in Example 1, locating a car dealership within the U.S. as presented in Example 2, and comparison shopping for a home appliance as presented in Example 3. For purposes of further illustration and clarity FIGS. 6A-6D shall be presented and discussed in conjunction with Example 1, FIGS. 7A-7D presented and discussed in connection with Example 2, and lastly FIG. 8 shall be presented and discussed with reference to Example 3.

### EXAMPLE 1

FIG. 6A illustrates one example of the present invention as it relates to presenting advertising content related to the sale of automobiles. As illustrated in FIG. 6A image panel 172 includes an image of an automobile traveling down a road. In the lower portion of the monitor are initially presented image panels 174, 176, 178, and 180. As illustrated each of these panels include different aspects of the advertised automobile. In the upper right hand corner of the monitor according to another aspect hereof the first image panel 172 in this example includes navigation buttons 171, 173, 175, 177 and 179. Here in this embodiment of this example, navigation button 171 provides a go-to-previous-slide function; navigation button 173 is to start or stop a slide show; navigation button 175 is to go to the next slide; navigation button 177 is to go one level up; and navigation button 179 is to go to the manufacturer's website. In this Example, navigation buttons 171, 173, 175, 177 and 179 remain available to the use at all levels. Also illustrated in image panel 172 in the upper left hand corner is a pull-down menu which lists an Overview, Continental GT, and Continental GTS. Continental GT when selected provides three options including Colors, Highlights, and Interior. Thus, in this example the user of this ad material may use the navigation buttons 171, 173, 175, 177, and 179; and/or the pull-down menu in the upper left hand corner; and/ or simply move his cursor to the next level of panels 174, 176, 178, and 180 for a zoomable increase in size of the selected image panel. In the case where the user in this Example selects image panel 174, the image therein as illustrated in FIG. 6B upon selection fills the full screen and the smaller images embedded therein at the third level are proportionally enlarged.

As now seen in further detail in FIG. 6B, the image panel 174 includes overlaid or imbedded image panels 188, 190, 192, 194, and 196 in a 5 die cluster arrangement as illustrated. Each of the images in these five panels show a side elevation view of the vehicle provided in one of five different colors. If the user employs the menu selection Continental GT then selects Colors from the three options, the cluster of color image panels 188, 190, 192, 194, and 196 will enlarge to fill the full area of the monitor. Alternatively, the user may simply point and click his curser anywhere on image 188 which will then zoom to full monitor size so that the car may be seen in the selected color in full screen size. The cluster of images in the upper right hand corner including image panels 198, 200, 202, 204, 206, 208, and 210 show various views of the interior of this model of the car. Further detailed views such as in panel 210 where a close up image of the dashboard is presented, or panel 208 for a detailed image of the shifter control and related control knobs are also presented at this level. Here similarly, if the user employs the menu selection Continental GT then selects Interior from the three options, the cluster of interior image panels 198, 200, 202, 204, 206, 208, and 210 will enlarge to fill the full area of the monitor. Alternatively, the user may simply point and click his curser on image 210, for example, which will then zoom to full monitor size so that the detailed close-up view of the dashboard instruments smoothly enlarges to full screen size. In the lower left hand corner of image panel 174, further presented are image and text panels 182, 184, and 186 each containing some amount of text and a corresponding image as illustrated. The image and text panel block 182 includes information about the torque of the automobile, the image panel 184 includes information about the space availability in the car illustrated by luggage shown in an open trunk, and image panel 186 includes information about the engine. As shown in image panel 186 two additional image panels 214, and 212 are illustrated and thus from the next deeper level of detail.

Next in FIG. 6C when the user selects image panel 186 by pointing and clicking on it, panel 186 will by the teachings hereof a zoom in size to enlarge to fill a larger portion or all of the monitor as represented here in FIG. 6C. Thus at this level image panel 186, including image and text now includes a correspondingly enlarged version of image panels 214 and 212.

Now with reference next to FIG. 6D, the user of the website has selected image panel 214, and there seen is the deepest level of pictorial and textual information. Now when selected as illustrated in FIG. 6D, the panel 214 takes a predominant portion of the viewable physical space on the monitor by zooming to the set size to fill substantially all the available viewing area on the monitor.

With reference again to FIG. 6A, the user may proceed to explore the site by selecting the remaining second level panes 176, 178, and 180; and then further explore each and every cluster of panels or individual pages presented therein until having looked at all pages on each level down until the deepest level. Thus as illustrated here in this Example, a user may easily and readily fully explore all of the pages of this advertising material and be assured that no page was overlooked.

### EXAMPLE 2

With reference now to FIG. 7A there is presented a first page of a sub-site for this example which is directed to the Leopard automobile manufacturing company sub-site for quickly finding a dealer within its national dealer network. As illustrated, the main page or first level parent page of the sub-site includes a map of the United States, which is broken down first into states, then each state into counties, and then lastly by dealerships with the county. Here a user of this sub-site desiring to find a dealership in a county within California would roll his cursor over the State of California, and click anywhere on the state whereupon the screen according to the tools and templates hereof zooms in so that the full screen of the monitor is the size of the State of California as shown in FIG. 7B. Now with continuing reference to FIG. 7B all of the counties and principle cities of the State of California are illustrated in larger detail. In the case where the user is interested in the Southern California counties of Los Angeles, San Diego, or Orange county, the user can simply click on the desired county and the sub-site will automatically zoom to fill the screen with a graphical representative in full size of the county as represented in FIG. 7C. Also shown in FIG. 7C is a listing of the dealerships for the selected county, Orange County. Here FIG. 7C shows five dealerships that sell Leopard Automobiles in Orange County, Calif. On the level of the sub-site illustrated in FIG. 7C, the user is still in the sub-site of the manufacturer. However, here the icons or links showing new car inventory, used car inventory, the parts department, and the service department of each of the dealerships are a link directly to that particular dealer's website. Thus, if the user here in FIG. 7C clicks on Dealership #1 as a link, the screen will go to a full size image of the home page of dealership number 1. Alternatively, the user here at FIG. 7C may click on the new car inventory of the first listed dealership and then be linked to all the new cars in then current inventory at this dealership. Thus in this manner when the user in FIG. 7C clicks on the new car inventory of Dealership #1, the user will be linked to the new car sub-site of this particular dealership wherein all the new automobiles in current inventory at Dealership #1 are presented in the flat site format such as that exemplified next in FIG. 7D.

### EXAMPLE 3

Reference now is to FIG. 8 which represents a supersite as discussed above in the Detailed Description section hereof. Here in this example, the supersite is compiled by conducting a search query directed to the purchase of a new refrigerator where the user/consumer is interested in comparison shopping. Thus in this example, after the website user through his personal computer has conducted a search for refrigerators, the search engine in combination with the tools and templatizing methods hereof return a search result page as illustrated in FIG. 8. Here shown are three main image panels 216, 218, and 220. As illustrated the image panel 216 has been derived from some of the pages from the website of the hypothetical retailer named Appliance Depot. Similarly, the pages presented in the image and text panel 218 have been derived from a hypothetical retailer of refrigerators and appliances named Best Purchase. And lastly, image panel 220 has been compiled from a subset of web pages from the website of the fictional retailer Refrigerator World. As further illustrated in panel 216, Appliance Depot offers two general types of refrigerators, side-by-side refrigerators as illustrated in image and text panel 222, and top and bottom refrigerators as illustrated in panel 224. Similarly, side-by-side refrigerators are shown in panel 226 for Best Purchase and in panel 230 for Refrigerator World. In a corresponding manner, the top and bottom refrigerators at Best Purchase are shown in image panel 228 at level 2 within the Best Purchase panel 218, and similarly the top and bottom refrigerators offered by Refrigerator World are shown in panel 232. Thus according to the additional aspects presented in this illustrative example of one particular embodiment of the present invention, here the search results comprise a supersite for comparison shopping of refrigerators such that side-by-side refrigerators from three main sources are provided in a juxtaposed manner as illustrated in FIG. 8. The three sources were ranked or judged to be the most pertinent sources by the dynamic ranker in the search engine as based on the initial search query. The combined presentation of these three subsites in the flat page format allows the user to readily comparison shop. Now since the user may be interested in top and bottom configured refrigerators the search results include separate clusters of individual pages from the three websites compiling in the flat manner the various offerings in this refrigerator style and type.

In further use of this material as presented in FIG. 8, in the case where the user is only interested in side-by-side refrigerators, the user can simply click on any one of the third level thumbnails which will then immediately enlarge to fill the screen. For example, in Appliance Depot imbedded within side-by-side panel 222 are thumbnail panels 234, 236, 238, 240, 242, 244, 246, and 248. In a similar manner the user may click on any of the level three thumbnails in the Best Purchase main panel 218, then on the individual thumbnail images in the side-by-side panel 232 to look at the individual side-by-side refrigerators offered by Best Purchase. And similarly, with side-by-side refrigerators of Refrigerator World illustrated in panel 230. Thus in this manner if the user finds the same side-by-side refrigerator at each of the three different websites, comparison shopping in terms of price, customer service, or other such information provided on the individual level three panels may be readily presented to the user to provide a more friendly, intuitive, and complete navigation as well as quick and easy visual comparison shopping from different website offerings.

While this invention has been described in detail with reference to certain embodiments and examples, it should be appreciated that the present invention is not limited to those precise embodiments or in any way to the examples given by way of illustrative purposes. Rather, in view of the present disclosure which describes the current best mode for practicing the invention, many modifications and variations would present themselves to those of skill in the art without departing from the scope and spirit of this invention. The scope of the invention is, therefore, indicated by the following claims rather than by the foregoing description. All changes, modifications, and variations coming within the meaning and range of equivalency of the claims are to be considered within their scope.

What is claimed is:

1. A method of presenting information on a display monitor within a computing environment, said method comprising the steps of:
accessing a website containing a related collection of electronic pages;
crawling said website to obtain raw image data for at least some of each of said pages;
porting said raw image data into a template so that each of said crawled pages is converted into a corresponding information panel containing a mapping of the content of its respective corresponding page; and
displaying each of said information panels on a respective display monitor so all of said panels are viewable to a user in a single screen shot.

2. The method according to claim 1 wherein said information panels are layered on top of each other in a predetermined manner to thereby create levels of information.

3. The method according to claim 2 wherein when said user selects a particular level, the information panels on said particular level enlarge to fill the available viewable space on said respective display monitor to thereby create a full screen shot of said selected particular level.

4. The method according to claim 1 wherein when said user selects a particular information panel, that information panel enlarges to fill the available viewable space on said respective display monitor to thereby create a full screen shot of said selected information panel.

5. The method according to claim 2 wherein the information panels in consecutive levels are smaller than the information panels in a next prior level so that at least a portion of all of said information panels on all levels is viewable in a single screen shot.

6. The method according to claim 2 including the further step of providing a menu containing a listing of at least some of said levels so that a user may employ said menu to jump from level to level whereupon when a particular level is selected from said menu, the panels on said level adjust in size to fill all the viewable space on said display monitor.

7. The method according to claim 1 including the further step of providing a menu containing a listing of at least some of the information panels so that a user may employ said menu to jump from panel to panel whereupon when a particular panel is selected from said menu, said particular panel adjusts in size to fill all the viewable space on said display monitor.

8. The method according to claim 2 including the further step of providing a link on one level so that a user may employ said link to jump to a different level whereupon when said link is employed, the panels on said different level adjust in size to fill all the viewable space on said display monitor.

9. The method according to claim 1 including the further step of providing at least one link in one information panel so that a user may employ said link to jump to a different information panel whereupon when said link is employed, said different panel adjusts in size to fill all the viewable space on said display monitor.

10. The method according to claim 1 wherein said crawling step includes obtaining raw image data for all of said pages in said website.

11. A networked computer system for use in presenting a related collection of electronic pages in a flat format, said computer system comprising:
at least one server including stored pages capable of being searched and retrieved electronically;
memory for storing a search engine including a ranker and executable methods of searching for desired types of said stored pages;
an input device for inputting a search query directed to retrieving a respective collection of said desired types of said stored pages;
a processor operatively linked to said input device for processing said search query;
a browser operatively associated with said processor for cooperatively engaging a front end of said search engine so that when said search engine receives said search query from a user, said search engine retrieves a set of said stored pages relevant to said search query;
a template that receives each retrieved page in a predetermined format so that each retrieved page is converted to a corresponding information panel; and
a display monitor for displaying each of said information panels so all of said retrieved and converted pages are viewable to a user in a single screen shot.

12. The system according to claim 12 wherein said retrieved pages are obtained from at least two different websites.

13. A method of arranging and presenting information on a display monitor within a computing environment, said method comprising the steps of:
accessing a website containing a related collection of electronic pages;
crawling said website to obtain raw image data for at least some of each of said pages;
porting said raw image data for each of said pages into a corresponding information panel containing a mapping of the content of its respective corresponding page;
arranging said information panels in a desired format; and
displaying each of said information panels on a respective display monitor so all of said panels are viewable to a user in a single screen shot.

14. The method according to claim 13 wherein said information panels are layered on top of each other in a predetermined manner to thereby create levels of information.

15. The method according to claim 14 wherein when said user selects a particular level, the information panels on said particular level enlarge to fill the available viewable space on said respective display monitor to thereby create a full screen shot of said selected particular level.

16. The method according to claim 13 wherein when said user selects a particular information panel, that information panel enlarges to fill the available viewable space on said respective display monitor to thereby create a full screen shot of said selected information panel.

17. The method according to claim 14 wherein the information panels in consecutive levels are smaller than the information panels in a next prior level so that at least a portion of all of said information panels on all levels is viewable in a single screen shot.

18. The method according to claim 14 including the further step of providing a menu containing a listing of at least some of said levels so that a user may employ said menu to jump from level to level whereupon when a particular level is selected from said menu, the panels on said level adjust in size to fill all the viewable space on said display monitor.

19. The method according to claim 13 including the further step of providing a menu containing a listing of at least some of the information panels so that a user may employ said menu to jump from panel to panel whereupon when a particular panel is selected from said menu, said particular panel adjusts in size to fill all the viewable space on said display monitor.

20. The method according to claim 14 including the further step of providing a link on one level so that a user may employ said link to jump to a different level whereupon when said link is employed, the panels on said different level adjust in size to fill all the viewable space on said display monitor.
